(19) United States
(12) Patent Application Publication
(10) Pub. No.: US 2023/0106936 A1
(43) Pub. Date: Apr. 6, 2023

(54) Interactive Gaming in Sports

(71) Applicant: STATS LLC, Chicago, IL (US)

(72) Inventors: Daniel Richard Dinsdale, London (GB); Christian Schober, Graz (AT); David Grimm, Hamburg (DE); John Dickinson, North Yorkshire (GB); Andrew Skweres, Highland Park, IL (US); Christian Marko, Graz (AT); Patrick Joseph Lucey, Chicago, IL (US); Hayley Redgate, Sandhurst (GB)

(73) Assignee: STATS LLC, Chicago, IL (US)

(21) Appl. No.: 17/934,756

(22) Filed: Sep. 23, 2022

Related U.S. Application Data
(60) Provisional application No. 63/261,593, filed on Sep. 24, 2021.

(51) Int. Cl. G07F 17/32; G06Q 50/34

(52) U.S. Cl. CPC G07F 17/3288; G06Q 50/34

(57) ABSTRACT

A computing system generates an interactive game space for predicting an outcome of an event during a live game. The computing system identifies a prediction event in the live game. The computing system receives event data for the live game up to the prediction event. The computing system identifies pre-game player specific data for each player involved in the prediction event. The computing system generates a probability distribution for a set of possible outcomes for the prediction event based on the event data and the pre-game player specific data. The computing system presents the probability distribution to a user participating in the interactive game space. The computing system receives a proposed outcome for the prediction event from the user participating in the interactive game space. The computing system determines that the proposed outcome was correct. The computing system grants points to the user within the interactive game space.

### CROSS-REFERENCE TO RELATED APPLICATIONS

This application claims priority to U.S. Provisional Application Ser. No. 63/261,593, filed Sep. 24, 2021, which is hereby incorporated by reference in its entirety.

### FIELD OF THE DISCLOSURE

The present disclosure generally relates to system and method for generating an interactive game in the context of live sporting events.

### BACKGROUND

Sports fans increasingly have become more engaged with sports as sports analytics becomes more readily available to end users. Mobile providers have started to take advantage of the latest technology by providing users with the opportunity to view games on their mobile devices.

### SUMMARY

In some embodiments, a method is disclosed herein. A computing system generates an interactive game space for predicting an outcome of an event during a live game. The computing system identifies a prediction event in the live game. The computing system receives event data for the live game up to the prediction event. The computing system identifies pre-game player specific data for each player involved in the prediction event. The computing system generates a probability distribution for a set of possible outcomes for the prediction event based on the event data and the pre-game player specific data. The computing system presents the probability distribution to a user participating in the interactive game space. The computing system receives a proposed outcome for the prediction event from the user participating in the interactive game space. The computing system determines that the proposed outcome was correct. The computing system grants points to the user within the interactive game space.

In some embodiments, a non-transitory computer readable medium is disclosed herein. The non-transitory computer readable medium includes one or more sequences of instructions, which, when executed by a processor, causes a computing system to perform operations. The operations include generating, by a computing system, an interactive game space for predicting an outcome of an event during a live game. The operations further include identifying, by the computing system, a prediction event in the live game. The operations further include receiving, by the computing system, event data for the live game up to the prediction event. The operations further include identifying, by the computing system, pre-game player specific data for each player involved in the prediction event. The operations further include generating, by the computing system, a probability distribution for a set of possible outcomes for the prediction event based on the event data and the pre-game player specific data. The operations further include presenting, by the computing system, the probability distribution to a user participating in the interactive game space. The operations further include receiving, by the computing system, a proposed outcome for the prediction event from the user participating in the interactive game space. The operations further include determining, by the computing system, that the proposed outcome was correct. The operations further include, based on the determining, granting, by the computing system, points to the user within the interactive game space.

In some embodiments, a system is disclosed herein. The system includes a processor and a memory. The memory has programming instructions stored thereon, which, when executed by the processor, causes the system to perform operations. The operations include generating an interactive game space for predicting an outcome of an event during a live game. The operations further include identifying by the computing system, a prediction event in the live game. The operations further include receiving event data for the live game up to the prediction event. The operations further include identifying pre-game player specific data for each player involved in the prediction event. The operations further include generating a probability distribution for a set of possible outcomes for the prediction event based on the event data and the pre-game player specific data. The operations further include presenting the probability distribution to a user participating in the interactive game space. The operations further include receiving a proposed outcome for the prediction event from the user participating in the interactive game space. The operations further include determining that the proposed outcome was correct. The operations further include, based on the determining, granting points to the user within the interactive game space.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a block diagram illustrating a prediction process, according to example embodiments.

FIG. 3 is a block diagram illustrating a prediction engine, according to example embodiments.

FIG. 4 illustrates an exemplary prediction process, according to example embodiments.

FIG. 5A illustrates an exemplary graphical user interface corresponding to an interface generated for an interactive game space, according to example embodiments.

FIG. 5B illustrates an exemplary graphical user interface corresponding to an interface generated for an interactive game space, according to example embodiments.

FIG. 5C illustrates an exemplary graphical user interface corresponding to an interface generated for an interactive game space, according to example embodiments.

FIG. 5D illustrates an exemplary graphical user interface corresponding to an interface generated for an interactive game space, according to example embodiments.

FIG. 6 is a flow diagram illustrating a method of generating an interactive gaming space, according to example embodiments.

FIG. 7 is a flow diagram illustrating a method of generating a prediction in sport, according to example embodiments.

FIG. 8 is a flow diagram illustrating a method of generating a prediction in sport, according to example embodiments.

FIG. 9A is a block diagram illustrating a computing device, according to example embodiments.

FIG. 9B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

One or more techniques disclosed herein provide an interactive prediction game, which may allow users to predict an outcome of each scoring opportunity throughout the course of a live game. For example, in the context of cricket, a user may be able to predict an outcome of each ball or bowl. In some embodiments, the user may be able to compete against other users that are making a similar prediction on their own user device. In some embodiments, the user may be able to compete against an artificial intelligence engine that is configured to generate its own predicted outcome of the event. In this manner, a user can compete against other users, against an artificial intelligence engine, or both throughout the course of a game, plurality of games, seasons, and the like.

While the below discussion is with respect to an interactive game in the context of cricket, those skilled in the art understand that these techniques may be applied to any sport, such as, but not limited to, football, basketball, baseball, soccer, tennis, rugby, hockey, and the like.

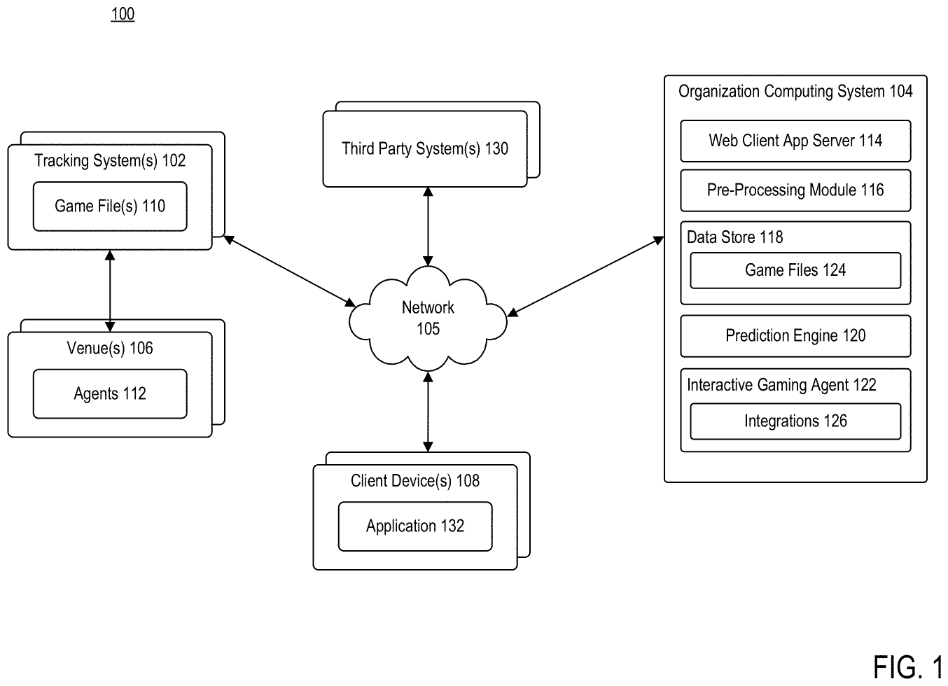

FIG. 1 is a block diagram illustrating a computing environment 100, according to example embodiments. Computing environment 100 may include tracking system 102, organization computing system 104, one or more client devices 108, and one or more third party systems 130 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™ ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106. For example, venue 106 may be configured to host a sporting event that includes one or more agents 112. Tracking system 102 may be configured to capture the motions of all agents (i.e., players) on the playing surface, as well as one or more other objects of relevance (e.g., ball, referees, etc.). In some embodiments, tracking system 102 may be an optically-based system using, for example, a plurality of fixed cameras. For example, a system of six stationary, calibrated cameras, which project the three-dimensional locations of players and the ball onto a two-dimensional overhead view of the court may be used. In another example, a mix of stationary and non-stationary cameras may be used to capture motions of all agents on the playing surface as well as one or more objects or relevance. As those skilled in the art recognize, utilization of such tracking system (e.g., tracking system 102) may result in many different camera views of the court (e.g., high sideline view, free-throw line view, huddle view, face-off view, end zone view, etc.). In some embodiments, tracking system 102 may be used for a broadcast feed of a given match. In such embodiments, each frame of the broadcast feed may be stored in a game file 110.

In some embodiments, game file 110 may further be augmented with other event information corresponding to event data, such as, but not limited to, game event information (pass, made shot, turnover, etc.) and context information (current score, time remaining, etc.).

Tracking system 102 may be configured to communicate with organization computing system 104 via network 105. Organization computing system 104 may be configured to manage and analyze the data captured by tracking system 102.

Organization computing system 104 may include at least a web client application server 114, a pre-processing module 116, a data store 118, a prediction engine 120, and an interactive gaming agent 122. Each of pre-processing module 116 and interactive gaming agent 122 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Data store 118 may be configured to store one or more game files 124. Each game file 124 may include video data of a given match. For example, the video data may correspond to a plurality of video frames captured by tracking system 102. In some embodiments, the video data may correspond to broadcast data of a given match, in which case, the video data may correspond to a plurality of video frames of the broadcast feed of a given match. Generally, such information may be referred to herein as “tracking data.”

Pre-processing module 116 may be configured to process data retrieved from data store 118. For example, pre-processing module 116 may be configured to generate game files 124 stored in data store 118. For example, pre-processing module 116 may be configured to generate a game file 124 based on data captured by tracking system 102. In some embodiments, pre-processing module 116 may further be configured to store tracking data associated with each game in a respective game file 124. Tracking data may refer to the (x, y) coordinates of all players and balls on the playing surface during the game. In some embodiments, pre-processing module 116 may receive tracking data directly from tracking system 102. In some embodiments, pre-processing module 116 may derive tracking data from the broadcast feed of the game.

In some embodiments, pre-processing module 116 may be further configured to supplement each game file 124 with corresponding game context. For example, for cricket, for each event or ball, a game file 124 may include one or more of batter identifier (e.g., batter_id), a bowler identifier (e.g., bowler_id), the amount of runs each team has, the amount of outs a given team has, the balls remaining, a required run rater, bowler runs, bowler balls bowled, bowler wickets, batter runs, and batter balls faced.

Pre-processing module 116 may further be configured to process live event data (e.g., ball-by-ball data) based on live tracking data. For example, for each event, pre-processing module 116 may supplement the live tracking data with one or more of batter identifier (e.g., batter_id), a bowler identifier (e.g., bowler_id), the amount of runs each team has, the amount of outs a given team has, the balls remaining, a required run rater, bowler runs, bowler balls bowled, bowler wickets, batter runs, and batter balls faced.

In some embodiments, pre-processing module 116 may further be configured to generate pre-game personalized player descriptors for each player. For example, pre-processing module 116 may generate pre-game personalized player descriptors for each bowler and batter. Exemplary pre-game personalized player descriptors for a player, such as a batter, may include, but is not limited to, one or more of runs per out, runs per ball, aggression per ball, 0-run proportion, 1-run proportion, 2-run proportion, 3-run proportion, 4-run proportion, 6-run proportion, wide-rune proportion, wicket run proportion, and the like. In some embodiments, the pre-game personalized player descriptions may be averages from the last X-games. In some embodiments, the pre-game personalized player descriptions may be season averages. Exemplary pre-game personalized player descriptions for a player, such as a bowler, may include, but is not limited to, one or more of balls per out, runs per ball, aggression per ball, 4/6 run proportion, 0-run proportion, and the like. In some embodiments, pre-processing module 116 may be configured to process live event data in real-time or near real-time. For example, pre-processing module 116 may generate pre-game personalized predictions at a latency of about 0.04 seconds.

Prediction engine 120 may include a prediction model or prediction models trained to generate a set of probabilities for an event, based on the live-event data and pre-game personalized predictions. For example, prediction engine 120 may receive as input live event data (e.g., ball-by-ball data) and pre-game personalized player descriptions and generate, as output, a set of probabilities, with each probability corresponding to a possible outcome for an event. Using a specific example, in those embodiments in which the event is a ball to be bowled to a batter, prediction engine 120 may generate eight probabilities, with each probability corresponding to a likelihood of each outcome occurring. Exemplary outcomes may include a wide, a wicket, zero, one, two, three, four, and six. Accordingly, based on the inputs, prediction engine 120 may output a probability of each outcome occurring. To accommodate gameplay in the live game context, prediction model(s) of prediction engine 120 may be trained to generate the set of probabilities in a real-time or near real-time manner. For example, prediction engine 120 may generate the set of probabilities at a low latency (e.g., 0.1-0.2 seconds). In some embodiments, prediction model(s) of prediction engine 120 may be representative of a random forest model personalized for the specific task of generating the set of probabilities of each of outcome of set of possible outcomes.

In some embodiments, based on the live-event data and pre-game personalized predictions, prediction engine 120 may be further configured to predict a next pitch location. For example, prediction engine 120 may generate a probability of a next pitch being: full, good, or short.

In some embodiments, based on the live-event data and pre-game personalized predictions, prediction engine 120 may be further configured to predict a next ball shot location. For example, prediction engine 120 may generate a probability of a next ball being located at various locations on the pitch (e.g., eight location probabilities corresponding to eight locations on the pitch).

As those skilled in the art understand, each sporting event may include its own separate rules. For example, in cricket, there are four types of cricket events: test cricket, one day internationals, T20 internationals, and the Hundred. Using another example, despite there being a general sport of basketball, basketball includes different leagues with different rules. For example, basketball events may include: NBA games, NCAA men's games, WNBA games, NCAA women's games, FIBA, and the like. Accordingly, prediction engine 120 may include a plurality of prediction models. Each prediction model of prediction engine 120 may correspond to a specific event type. For example, for cricket, prediction engine 120 may include a first prediction model for test cricket, a second prediction model for one day internationals, a third prediction model for T20 internationals, and a fourth prediction model for The Hundred. In some embodiments, the plurality of prediction models in cricket may include separate prediction models in each category for men's and women's cricket. Each prediction model may be trained on its own set of historical data. For example, the test cricket prediction model may be trained on historical test cricket data and the one day internationals cricket prediction model may be trained on historical one day internationals cricket data.

In some embodiments, rather than include several different prediction models, prediction engine 120 may update the model parameters of a given prediction model based on the format of the game. For example, each game format may include its own set of model parameters. In operation, prediction engine 120 may update the parameters of its prediction model using the set of model parameters corresponding to that game type.

Interactive gaming agent 122 may be configured to generate an interactive gaming space for users. For example, interactive gaming agent 122 may be configured to generating an interactive gaming space for a user or users to compete. Interactive gaming agent 122 may be configured to maintain a score for each user based on a user's selection of an event outcome for a given event. Generally, a user may participate in various competitions of various durations. For example, a user may participate in a daily competition, a week- or month-long competition, a season competition, a tournament competition and the like. In some embodiments, the user may request a private interactive gaming space, in which the user invites their friends to join. In some embodiments, the user may join an open competition. The user may gain points by correctly prediction various outcomes of various events in the game. Continuing with the above, for each correctly guessed next ball prediction, the user may gain a point. In some embodiments, the user may be able to receive bonus points, for example, if they predicted the correct outcome multiple times in a row or, in another example, they play multiple days in a row. Accordingly, in this manner, interactive gaming agent 122 may be configured to maintain a score for each user.

In some embodiments, interactive gaming agent 122 may selectively provide users with information based on the user's subscription level. For example, for a free-to-play version of the game, the user may only be allowed to input their own prediction for how an event will turn out. In comparison, in a premium version of the game (i.e., a paid subscriber), the user may be provided with additional insights, such as, but not limited to, next ball probabilities, next pitch location probabilities, and/or next ball location probabilities generated by prediction engine 120.

In some embodiments, interactive gaming agent 122 may include one or more integrations 126. One or more integrations 126 may allow a user to interact with one or more third party systems 130. For example, one or more integrations 126 may allow a user to interact with one or more sports betting operators to submit bets in real-time or near real-time during the course of the game. In this manner, interactive gaming agent 122 may provide sports betting operators with the ability to create betting opportunities on a pitch-by-pitch or ball-by-ball level, thus increasing the amount of gaming opportunities available to sports betting operators.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 132. Application 132 may be representative of a web browser that allows access to a website or a stand-alone application. Client device 108 may access application 132 to access one or more functionalities of organization computing system 104. Client device 108 may communicate over network 105 to request a webpage, for example, from web client application server 114 of organization computing system 104. For example, client device 108 may be configured to execute application 132 to participate in an interactive game generated by interactive gaming agent 122. In some embodiments, client device 108 may be configured to execute application 132 to create or join an interactive gaming space generated by interactive gaming agent 122. The content that is displayed to client device 108 may be transmitted from web client application server 114 to client device 108, and subsequently processed by application 132 for display through a graphical user interface (GUI) of client device 108.

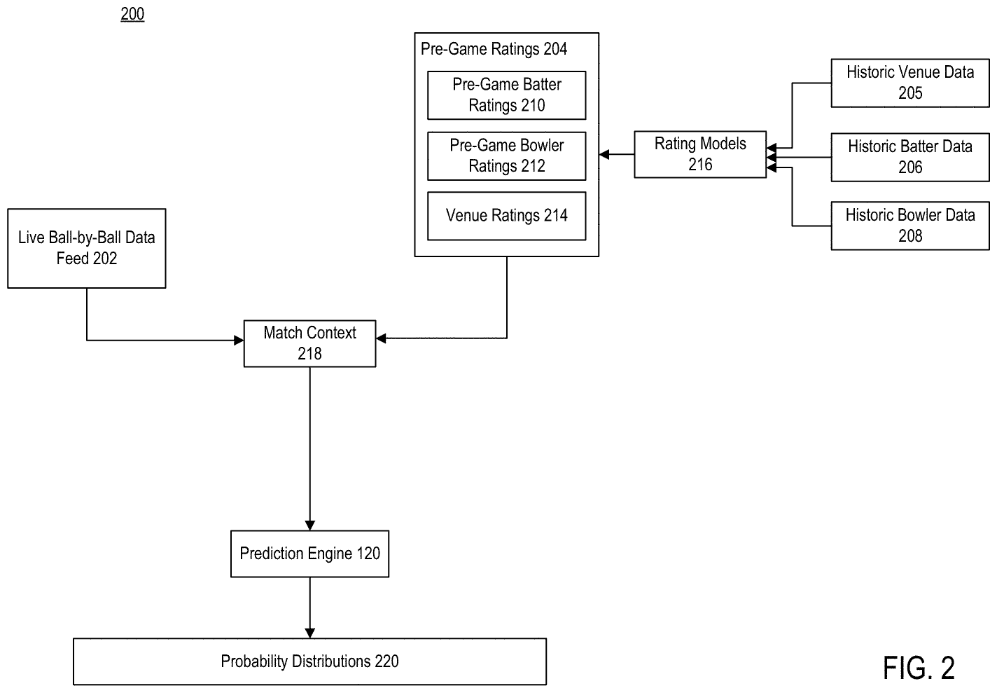

FIG. 2 is a block diagram illustrating a prediction process 200, according to example embodiments. As shown, prediction process 200 may include a data collection phase. During data collection phase, pre-processing module 116 may be configured to receive a live ball-by-ball data feed 202. Live ball-by-ball data feed 202 may include data related to the current pitch or event. For example, live ball-by-ball data feed 202 may include, but is not limited to, one or more of batter identifier (e.g., batter_id), a bowler identifier (e.g., bowler_id), the amount of runs each team has, the amount of outs a given team has, the balls remaining, a required run rate, bowler runs, bowler balls bowled, bowler wickets, batter runs, batter balls faced, team and match run rate, team and match wicket rate, current batter score, current bowler figures, and the like.

In some embodiments, prediction process 200 may further include a pre-game ratings phase. During pre-game ratings phase, pre-processing module 116 may generate pre-game ratings 204 from historic batter data 206 and historic bowler data 208. In some embodiments, pre-game ratings 204 may include pre-game batter ratings 210. Pre-game batter ratings 210 may be generated based at least in part on historic batter data 206. Pre-game batter ratings 210 may be representative of information associated with a batter involved in the upcoming prediction event. Exemplary pre-game batter ratings 210 may include, but are not limited to, one or more of runs per out, runs per ball, aggression per ball, 4-run proportion, 6-run proportion, 1-3 run proportion, 0-run proportion, and the like. In operation, to generate pre-game batter ratings 210, historic batter data 206 may be input to rating models 216. Rating models 216 may be representative of one or more Bayesian models configured to generate pre-game ratings 204.

In some embodiments, pre-game ratings 204 may include pre-game bowler ratings 212. Pre-game bowler ratings 212 may be generated based at least in part on historic bowler data 208. Historic bowler data 208 may be representative of information associated with a bowler involved in the upcoming prediction event. In some embodiments, pre-processing module 116 may derive or generate historic bowler data 208 from historical game files 124 in data store 118. Exemplary pre-game bowler ratings 212 may include, but are not limited to, one or more of balls per out, runs per ball, aggression per ball, 4/6 run proportion, 0 run proportion, and the like. In operation, to generate pre-game bowler ratings 212, historic bowler data 208 may be input to rating models 216. Rating models 216 may be representative of one or more Bayesian models configured to generate pre-game ratings 204.

In some embodiments, pre-processing module 116 may further be configured to generate venue ratings 214. Historic venue data 205 may be representative of information associated with a venue in which the game is taking place. In some embodiments, pre-processing module 116 may derive or generate venue ratings from historical game files 124 in data store 118. Exemplary venue ratings 214 may include, but are not limited to, but are not limited to, one or more of balls per out, runs per ball, aggression per ball, 4/6 run proportion, 0 run proportion, and the like. In operation, to generate venue ratings 214, historic venue data 205 may be input to rating models 216. Rating models 216 may be representative of one or more Bayesian models configured to generate pre-game ratings 204.

In some embodiments, prediction process 200 may include match context phase. During match context phase, live ball-by-ball data feed 202 may be combined with pre-game ratings 204 to generate match context 218. Match context 218 may include in-game knowledge (e.g., match performance so far and current match situation) combined with pre-game knowledge (e.g., pre-game ratings 204).

In some embodiments, prediction process 200 may include a prediction phase. During prediction phase, match context 218 may be provided, as input, to prediction engine 120. As output, prediction engine 120 may generate probability distributions 220 for the upcoming prediction event. For example, when generating a next ball prediction, prediction engine 120 may generate a probability distribution 220 representing the probability of each event occurring, i.e., a probability for each of wide, wicket, zero, one, two, three, four, and six.

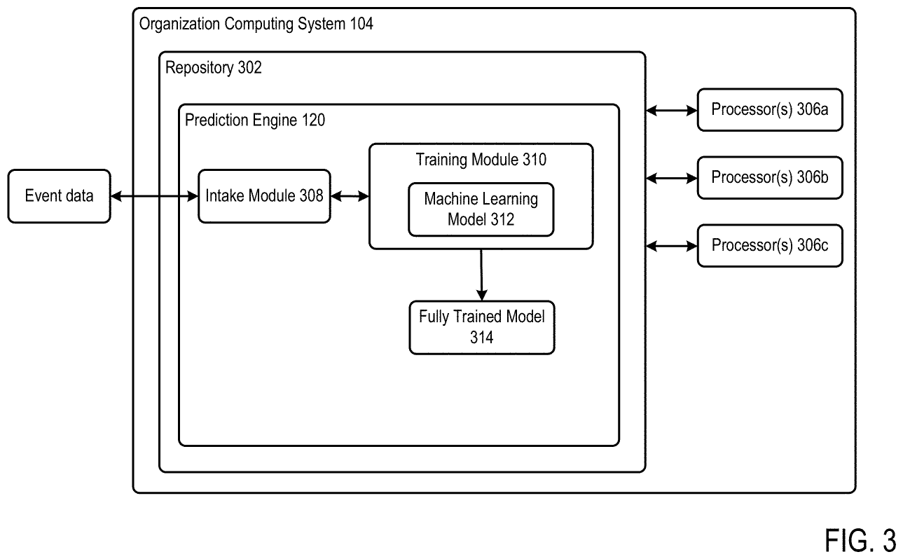

FIG. 3 is a block diagram of organization computing system 104, according to example embodiments. As shown, organization computing system 104 may include a repository 302. The repository 302 can include one or more data storage nodes that may include instructions. The repository 302 can interact with processors 306a, 306b, and/or 306c to implement prediction engine 120 as described herein.

Prediction engine 120 may be configured to train a model using a training data set to generate a set of probabilities for an event. Prediction engine 120 may include intake module 308 and training module 310. Each of intake module 308 and training module 310 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Intake module 308 may be configured to receive historical event data from pre-processing module 116. For example, intake module 308 may be configured to receive a plurality of historical game files 124. Intake module 308 may be configured to generate a plurality of training data sets based on the model being trained. For example, in some embodiments, intake module 308 may generate a first training data set for training a T20 internationals prediction model by aggregating game files 124 corresponding to T20 international games; similarly, intake module 308 may generate a second training data set for training test cricket prediction model by aggregating game files 124 corresponding to test cricket.

In some embodiments, intake module 308 may determine that there is insufficient data for training a prediction model. As those skilled in the art understand, when new iterations of a game may be introduced, there may not be sufficient historical data for training a corresponding model. Continuing with the above example, in cricket, the Hundred format is a new type of cricket, which involves innings of 100 balls bowled. Given the recency of its inception, there were only roughly thirty historical games worth of data for training its prediction model. Such limited data is typically insufficient to train an efficient model.

To account for this, in some embodiments, intake module 308 may be configured to derive or generate a training set for these models based on data corresponding to different events. In some embodiments, intake module 308 may include logic or intelligence that allows it to analyze a corpus of event data for that sport and identify or learn those portions of the data that are most applicable to the current model. Using a specific example, in the context of the Hundred format, intake module 308 may determine that the T20 data exhibits similarities to the Hundred format based on the rules of the Hundred format. For example, intake module 308 may determine that the T20 data exhibits similarities to the Hundred format but differs by 20 balls being bowled. Accordingly, intake module 308 may identify a subset of the T20 data (e.g., 100 balls being bowled) that is most similar to the pace of play in the Hundred format. In this specific example, intake module 308 may determine that the middle 20 balls bowled in the T20 data format may be removed for training the Hundred prediction model. Accordingly, in this manner, intake module 308 may be configured to generate a training data set for training prediction models that would otherwise not have sufficient training data.

Using another example, in the context of cricket, there is typically sufficient data for training cricket prediction models for men's cricket, while there is insufficient data for training cricket prediction models for women's cricket. Typically, women's cricket data is not representative of future outcomes across cricket formats. Similarly, as women's cricket has progressed, so too has the style of women's cricket. In recent years, the team scores have increased with high scoring shots becoming more prevalent. To account for this, intake module 308 may determine that historical men's cricket data is similar to current pace of play in women's cricket. Accordingly, intake module 308 may augment or supplement historic women's cricket data with historic men's cricket data, because, in the past, men's cricket has seen faster scoring rates that current and future women's cricket is moving towards. Accordingly, training module 310 may train women's cricket models with a hybrid of men's and women's cricket data for improved model performance.

Using another example, in the context of cricket, the style of game play may change. Accordingly, historical data may not be as relevant to the outcomes of current cricket matches. For example, over the last few years, cricket has seen an increase in aggressiveness of batters in the test match cricket format. The test match cricket format conventionally saw a cautious approach from batters, whose aim was to avoid getting out while slowly accumulating runs. Recently, there has been a shift towards a more aggressive approach, particularly in the final innings of the match when trying to chase down a score to win the game. To account for this shift in game play, intake module 308 may utilize data from other cricket formats that most closely resemble this style of play. In this context, historical one-day cricket data better captures this data. Accordingly, intake module 308 may supplement test match cricket data with one-day cricket data to improve model performance.

Training module 310 may be configured to train machine learning model 312 to generate expected values based on the actual values to generate fully trained model 314. For example, machine learning model 312 may be trained to evaluate control/station/process values, intermediate values, final output values, and determine adjustments to a station controller's input.

Training module 310 may be configured to train machine learning model 312 to generate a set of probabilities for an event type, based on the live-event data, pre-game personalized predictions, and the type of event. For example, training module 310 may train machine learning model 312 to generate a set of probabilities for the Hundred game format based on a training set generated by intake module 308 for the Hundred game format. Exemplary outcomes may include a wide, a wicket, zero, one, two, three, four, and six. In some embodiments, based on the live-event data and pre-game personalized predictions, training module 310 may train machine learning model 312 to predict a next pitch location. For example, training module 310 may train machine learning model 312 to generate a probability of a next pitch being: full, good, or short. In some embodiments, training module 310 may train machine learning model 312 to predict a next ball shot location. For example, training module 310 may train machine learning model 312 to generate a probability of a next ball being located at various locations on the pitch (e.g., eight location probabilities corresponding to eight locations on the pitch).

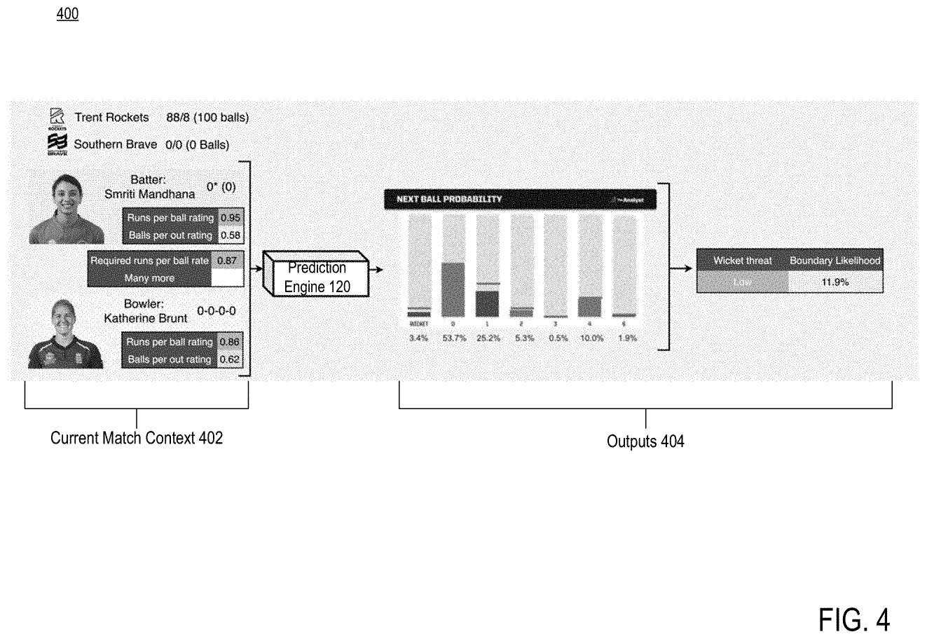

FIG. 4 illustrates an exemplary prediction process 400, according to example embodiments. As shown, current match context 402 may be provided to prediction engine 120. Current match context 402 may be generated similarly to match context 218, discussed above in conjunction with FIG. 2. Prediction engine 120 may generate outputs 404. In some embodiments, outputs 404 may include a probability distribution for a next ball prediction. In some embodiments, outputs 404 may include a simpler aggregation of the next ball predictions.

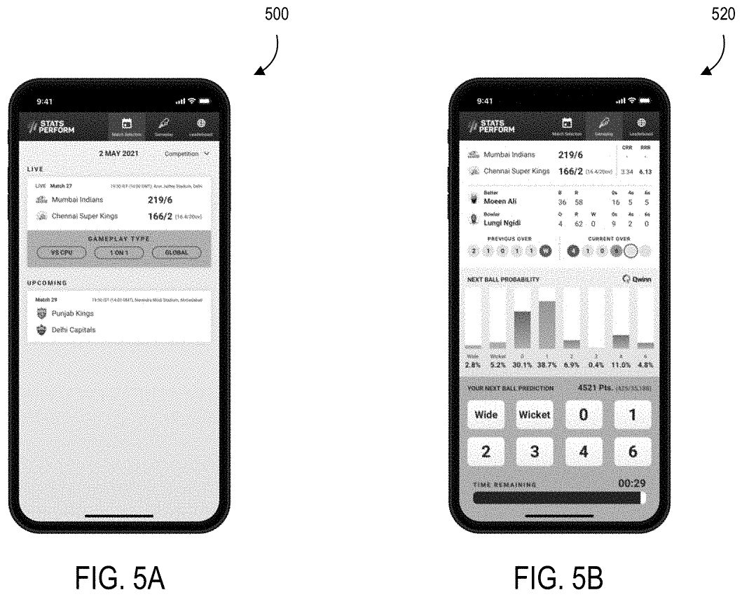

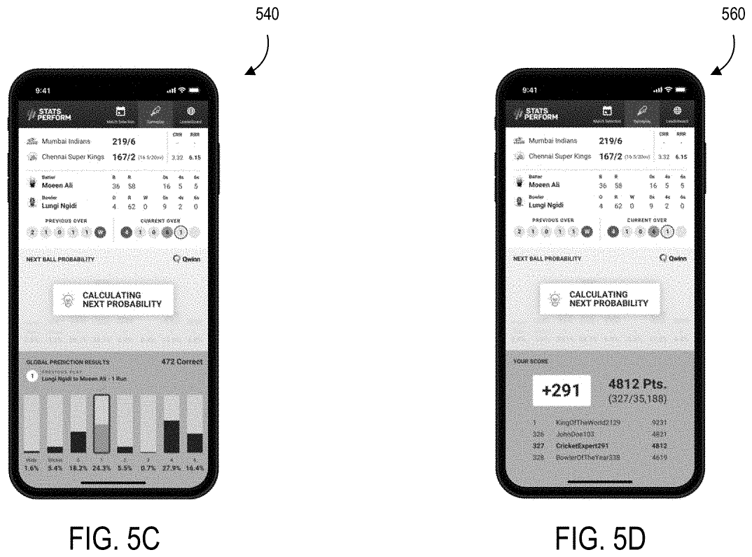

FIGS. 5A-5D illustrate graphical user interfaces (GUIs) associated with an interactive game, according to example embodiments. FIG. 5A illustrates an exemplary GUI 500 corresponding to an interface generated for the interactive game. As shown, a user may be presented with a schedule of games that are currently underway and games that are upcoming. GUI 500 includes two games: a first game that is currently underway between Mumbai Indians and Chennai Super Kings and a second game that is upcoming between Punjab Kings and Delhi Capitals. Because the first game is currently underway, the user may choose to participate in an interactive game for the first game. As shown, the user may be provided with various options. In some embodiments, the user may choose to compete against the CPU. For example, the user may compete against prediction engine 120 to if the user can beat output from prediction engine 120. In some embodiments, the user may choose a one-on-one format. In this format, the user may compete against another user to see who can correctly predict event outcomes. In some embodiments, the user may select a global format. In this format, the user may compete against a plurality of users to see who can correctly predict the most event outcomes.

FIG. 5B illustrates an exemplary GUI 520 corresponding to an interface generated for the interactive game. GUI 520 may be generated responsive to a user entering an interactive game generated by interactive gaming agent 122. Via GUI 520, a user may be able to place their prediction for the next ball. As shown, the user may be provided with an indication of the players involved in the next ball. For example, for the next prediction event, the batter is Moeen Ali and the bowler is Lungi Ngidi. GUI 520 may also include statistics corresponding to each player involved in the prediction event. Via GUI 520, the user may be provided with selectable graphical elements, such as wide, wicket, zero, one, two, three, four, and six. In some embodiments, the user may be provided with a visual indication corresponding to the time remaining for the user to make the selection.

As provided above, in some embodiments, GUI 520 may include computer-generated predictions generated by prediction engine 120. For example, as shown, GUI 520 may include a probability distribution for each possible outcome, as generated by prediction engine 120. In this manner, a user may consult with machine-generated predictions of the likelihood of each possible outcome.

FIG. 5C illustrates an exemplary GUI 540 corresponding to an interface generated for the interactive game. GUI 540 may include an indication as to whether the user correctly guessed the outcome of the ball. As shown, the user selected a “1” as their predicted outcome. GUI 540 includes an indication that “1” was correct.

FIG. 5D illustrates an exemplary GUI 560 corresponding to an interface generated for the interactive game. GUI 560 may include an indication as to how many points the user has, how many points the user gained from the correct prediction, and where the user stands in a leaderboard. As shown, the user gained 291 points by correctly predicting the outcome of the event. The user has 4812 points overall and is in 327^{th} place in the leaderboard.

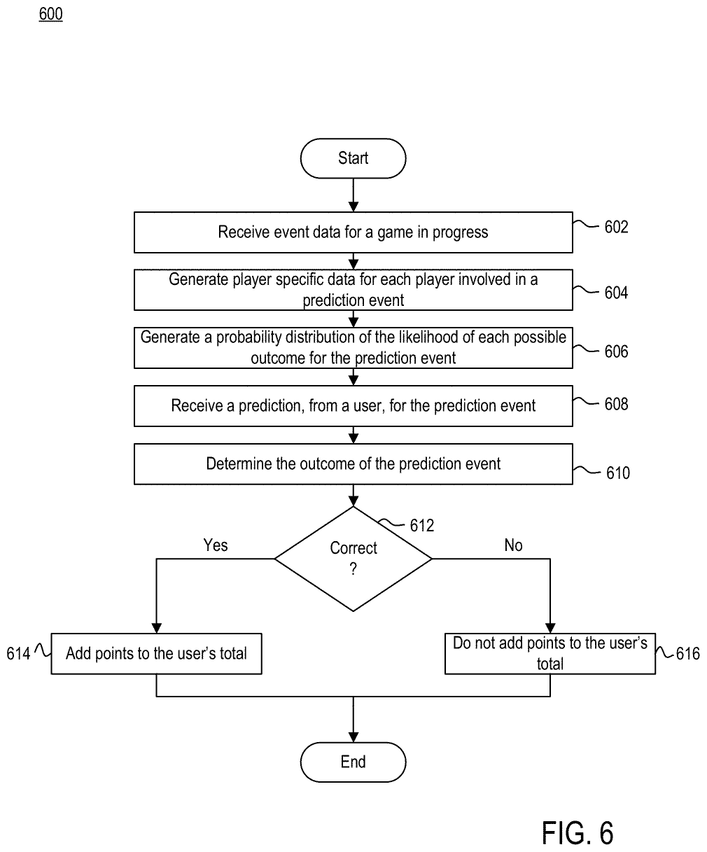

FIG. 6 is a flow diagram illustrating a method 600 of generating an interactive gaming space, according to example embodiments. Method 600 may begin at step 602.

At step 602, organization computing system 104 may receive event data for a game in progress. In some embodiments, the event data may be representative of play-by-play or ball-by-ball data for an upcoming prediction event. Exemplary event data may include, but is not limited to one or more of one or more of batter identifier (e.g., batter_id), a bowler identifier (e.g., bowler_id), the amount of runs each team has, the amount of outs a given team has, the balls remaining, a required run rater, bowler runs, bowler balls bowled, bowler wickets, batter runs, and batter balls faced.

At step 604, organization computing system 104 may identify pre-game batter features and pre-game bowler feature. Pre-processing module 116 may generate pre-game batter features and pre-game bowler features before commencement of the game. Pre-game batter features may be representative of information associated with a batter involved in the upcoming prediction event. In some embodiments, pre-processing module 116 may derive or generate pre-game batter features from historical game files 124 in data store 118. Exemplary pre-game batter features may include, but are not limited to, one or more of runs per out, runs per ball, aggression per ball, 4-run proportion, 6-run proportion, 1-3 run proportion, 0-run proportion, and the like. Pre-game bowler features 204 may be representative of information associated with a bowler involved in the upcoming prediction event. In some embodiments, pre-processing module 116 may derive or generate pre-game bowler features from historical game files 124 in data store 118. Exemplary pre-game bowler features may include, but are not limited to, one or more of balls per out, runs per ball, aggression per ball, 4/6 run proportion, 0 run proportion, and the like.

At step 606, organization computing system 104 may generate a probability distribution for the event based on the event data, pre-game batter features, and pre-game bowler features. In some embodiments, the probability distribution may correspond to a likelihood of each event outcome in a set of possible event outcomes may occur. To generate the probability distribution, prediction engine 120 may analyze the event data, the pre-gamer batter features, and the pre-game bowler features. For example, when generating a next ball prediction, prediction engine 120 may generate a probability of each event possibility occurring, i.e., a probability for each of wide, wicket, zero, one, two, three, four, and six.

At step 608, organization computing system 104 may receive a prediction for the prediction event from a user. For example, the user may provide organization computing system 104 with input via an interactive game space generating by interactive gaming agent 122. The prediction may correspond to one of a set of possible outcomes for the prediction event.

At step 610, organization computing system 104 may determine the outcome of the predicted event. For example, interactive gaming agent 122 may receive updated event data from tracking system 102. The updated event data may include an indication of the outcome of the event for which the prediction was made.

At step 612, organization computing system 104 may determine whether the user's prediction was correct. For example, interactive gaming agent 122 may compare the user's prediction to the actual outcome of the event. If, at step 612, interactive gaming agent 122 determines that the user's prediction was correct, then at step 614, interactive gaming agent 122 may add points to a user's score. If, however, at step 612, interactive gaming agent 122 determines that the user's prediction was incorrect, then at step 616, interactive gaming agent 122 may not add points to the user's score.

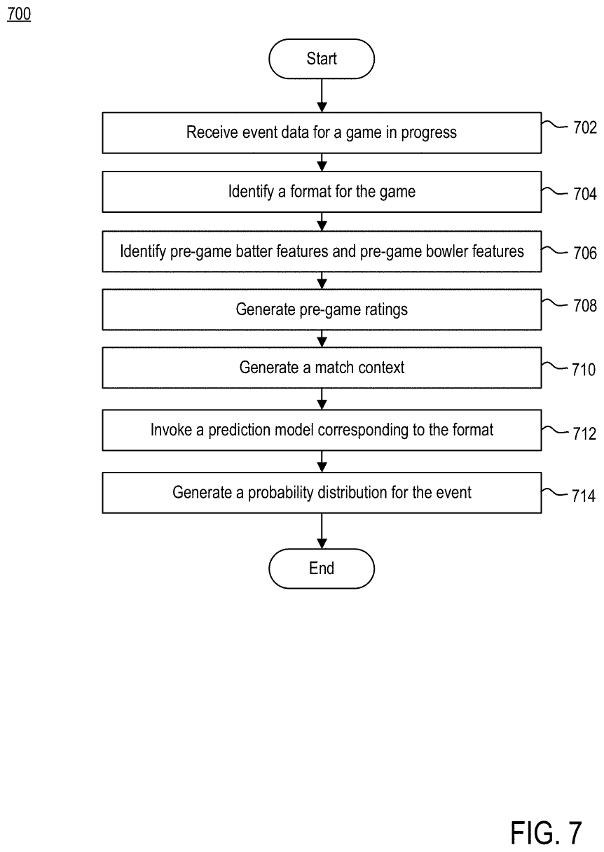

FIG. 7 is a flow diagram illustrating a method 700 of generating a prediction in sport, according to example embodiments. Method 700 may begin at step 702.

At step 702, organization computing system 104 may receive event data for a game in progress. In some embodiments, the event data may be representative of play-by-play or ball-by-ball data for an upcoming prediction event. Exemplary event data may include, but is not limited to one or more of one or more of batter identifier (e.g., batter_id), a bowler identifier (e.g., bowler_id), the amount of runs each team has, the amount of outs a given team has, the balls remaining, a required run rater, bowler runs, bowler balls bowled, bowler wickets, batter runs, and batter balls faced.

At step 704, organization computing system 104 may identify a format of the event corresponding to the event data. For example, as discussed above, certain sports may have different formats. In the context of cricket, cricket can include men's and women's test cricket, men's and women's one day internationals, men's and women's T20 internationals, and men's and women's Hundred.

At step 706, organization computing system 104 may identify pre-game batter features and pre-game bowler features. Pre-processing module 116 may generate pre-game batter features and pre-game bowler features before commencement of the game. Pre-game batter features may be representative of information associated with a batter involved in the upcoming prediction event. In some embodiments, pre-processing module 116 may derive or generate pre-game batter features from historical game files 124 in data store 118. Exemplary pre-game batter features may include, but are not limited to, one or more of runs per out, runs per ball, aggression per ball, 4-run proportion, 6-run proportion, 1-3 run proportion, 0-run proportion, and the like. Pre-game bowler features 204 may be representative of information associated with a bowler involved in the upcoming prediction event. In some embodiments, pre-processing module 116 may derive or generate pre-game bowler features from historical game files 124 in data store 118. Exemplary pre-game bowler features may include, but are not limited to, one or more of balls per out, runs per ball, aggression per ball, 4/6 run proportion, 0 run proportion, and the like.

At step 708, organization computing system 104 may generate pre-game ratings based on the pre-game batter features and pre-game bowler features. Pre-game ratings may include pre-game batter ratings, pre-game bowler ratings, and venue ratings. In some embodiments, to generate pre-game batter ratings, pre-processing module 116 may utilize rating models 216. For example, pre-processing module 116 may generate pre-game batter ratings by inputting pre-game batter features into rating models 216. In some embodiments, to generate pre-game bowler ratings, pre-processing module 116 may utilize rating models 216. For example, pre-processing module 116 may generate pre-game bowler ratings by inputting pre-game bowler features into rating models 216. In some embodiments, to generate venue ratings, pre-processing module 116 may utilize rating models 216. For example, pre-processing module 116 may generate venue ratings by inputting venue features into rating models 216.

At step 710, organization computing system 104 may generate a match context. To generate match context, pre-processing module 116 may combine the live ball-by-ball data feed with the pre-game ratings. Match context may include in-game knowledge (e.g., match performance so far and current match situation) combined with pre-game knowledge (e.g., pre-game ratings 204).

At step 712, organization computing system 104 may invoke a prediction model corresponding to the identified format. For example, for cricket, prediction engine 120 may include a first set of prediction models for men's and women's test cricket, a second set of prediction models for men's and women's one day internationals, a third set of prediction models for men's and women's T20 internationals, and a fourth set of prediction models for men's and women's Hundred. Each prediction model may be trained at least on historical data corresponding to that game format. Assuming, for example, the format of cricket in the target event is men's Hundred, organization computing system 104 may select the prediction model corresponding to men's Hundred.

At step 714, organization computing system 104 may generate a probability distribution for the event based on the match context. In some embodiments, the probability distribution may correspond to a likelihood of each event outcome in a set of possible event outcomes may occur. In some embodiments, such as when generating a next ball prediction, prediction engine 120 may generate a probability of each event possibility occurring, i.e., a probability for each of wide, wicket, zero, one, two, three, four, and six.

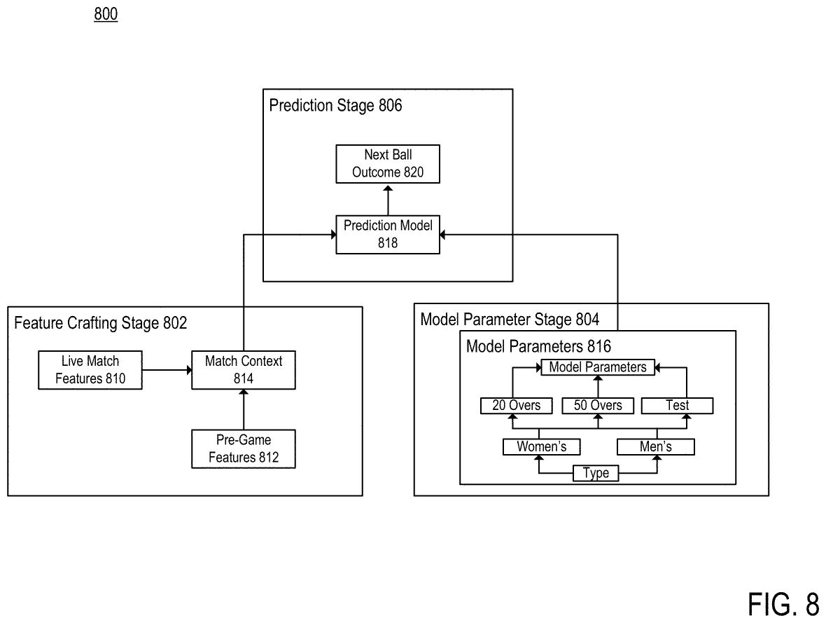

FIG. 8 is a flow diagram illustrating a method 800 of generating a prediction in sport, according to example embodiments. Method 800 may include a feature crafting stage 802, a model parameter stage 804, and a prediction stage 806.

At feature crafting stage 802, organization computing system 104 may receive event data for a game in progress. In some embodiments, the event data may be representative of play-by-play or ball-by-ball data for an upcoming prediction event. Exemplary event data may include, but is not limited to, one or more of one or more of batter identifier (e.g., batter_id), a bowler identifier (e.g., bowler_id), the amount of runs each team has, the amount of outs a given team has, the balls remaining, a required run rate, bowler runs, bowler balls bowled, bowler wickets, batter runs, and batter balls faced.

During the feature crafting stage 802, pre-processing module 116 may generate or derive live match features 810. Live match features 810 may include information related to match performance so far (e.g., current score, current inning, etc.), as well as the current match situation (e.g., batter vs. bowler). Pre-processing module 116 may combine the live match features 810 with pre-game features 812 (e.g., pre-game batter features, pre-game bowler features, venue features) to generate match context 814.

During model parameter stage 804, prediction engine 120 may generate model parameters 816 for a prediction model. To generate model parameters 816, prediction engine 120 may determine a type of match corresponding to the current match. As shown, prediction engine 120 may identify a type of match based on the league (e.g., men's or women's) and match format (e.g., 20 overs, 50 overs, test). Based on the type of match, prediction engine 120 may select model parameters 816 for the prediction model.

During prediction stage 806, prediction engine 120 may generate various predictions based on match context 814 and model parameters 816. For example, as shown, prediction engine 120 may update prediction model 818 using model parameters 816. Once updated, prediction model 818 may generate one or more predictions based on match context 814. As shown, prediction model 818 may generate a next ball outcome probability. In some embodiments, prediction model 818 may simulate next ball outcome 820. For example, based on match context 814, prediction model 818 may simulate the next ball outcome 820 a plurality of times to identify a probability distribution of the next ball.

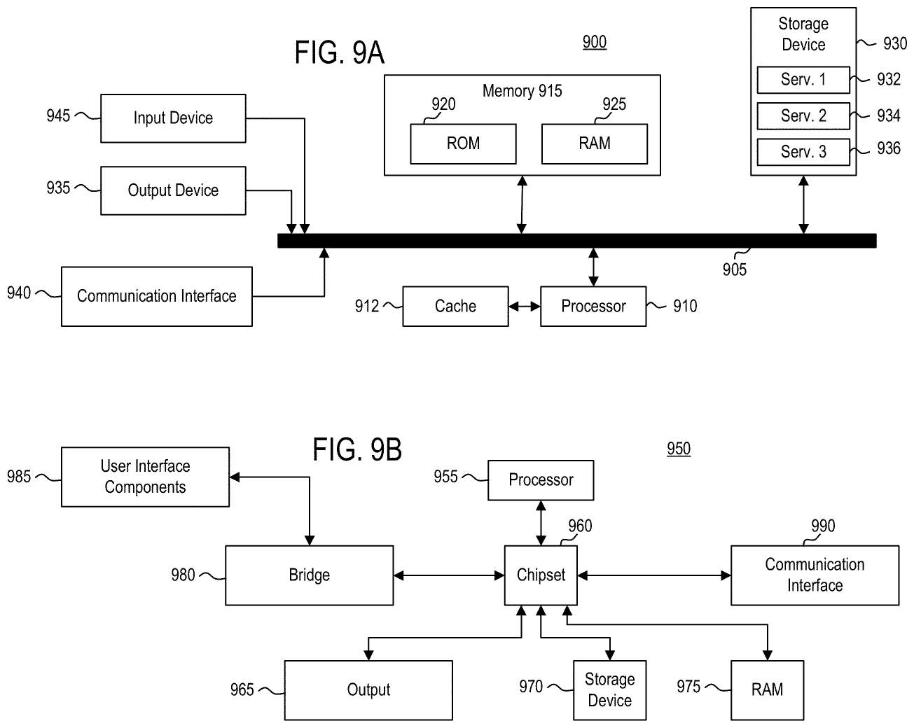

FIG. 9A illustrates an architecture of computing system 900, according to example embodiments. System 900 may be representative of at least a portion of organization computing system 104. One or more components of system 900 may be in electrical communication with each other using a bus 905. System 900 may include a processing unit (CPU or processor) 910 and a system bus 905 that couples various system components including the system memory 915, such as read only memory (ROM) 920 and random access memory (RAM) 925, to processor 910. System 900 may include a cache of high-speed memory connected directly with, in close proximity to, or integrated as part of processor 910. System 900 may copy data from memory 915 and/or storage device 930 to cache 912 for quick access by processor 910. In this way, cache 912 may provide a performance boost that avoids processor 910 delays while waiting for data. These and other modules may control or be configured to control processor 910 to perform various actions. Other system memory 915 may be available for use as well. Memory 915 may include multiple different types of memory with different performance characteristics. Processor 910 may include any general purpose processor and a hardware module or software module, such as service 1 932, service 2 934, and service 3 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction with the computing system 900, an input device 945 may represent any number of input mechanisms, such as a microphone for speech, a touch-sensitive screen for gesture or graphical input, keyboard, mouse, motion input, speech and so forth. An output device 935 (e.g., display) may also be one or more of a number of output mechanisms known to those of skill in the art. In some instances, multimodal systems may enable a user to provide multiple types of input to communicate with computing system 900. Communications interface 940 may generally govern and manage the user input and system output. There is no restriction on operating on any particular hardware arrangement and therefore the basic features here may easily be substituted for improved hardware or firmware arrangements as they are developed.

Storage device 930 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 925, read only memory (ROM) 920, and hybrids thereof.

Storage device 930 may include services 932, 934, and 936 for controlling the processor 910. Other hardware or software modules are contemplated. Storage device 930 may be connected to system bus 905. In one aspect, a hardware module that performs a particular function may include the software component stored in a computer-readable medium in connection with the necessary hardware components, such as processor 910, bus 905, output device 935, and so forth, to carry out the function.

FIG. 9B illustrates a computer system 950 having a chipset architecture that may represent at least a portion of organization computing system 104. Computer system 950 may be an example of computer hardware, software, and firmware that may be used to implement the disclosed technology. System 950 may include a processor 955, representative of any number of physically and/or logically distinct resources capable of executing software, firmware, and hardware configured to perform identified computations. Processor 955 may communicate with a chipset 960 that may control input to and output from processor 955. In this example, chipset 960 outputs information to output 965, such as a display, and may read and write information to storage device 970, which may include magnetic media, and solid-state media, for example. Chipset 960 may also read data from and write data to RAM 975. A bridge 980 for interfacing with a variety of user interface components 985 may be provided for interfacing with chipset 960. Such user interface components 985 may include a keyboard, a microphone, touch detection and processing circuitry, a pointing device, such as a mouse, and so on. In general, inputs to system 950 may come from any of a variety of sources, machine generated and/or human generated.

Chipset 960 may also interface with one or more communication interfaces 990 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 955 analyzing data stored in storage device 970 or RAM 975. Further, the machine may receive inputs from a user through user interface components 985 and execute appropriate functions, such as browsing functions by interpreting these inputs using processor 955.

It may be appreciated that example systems 900 and 950 may have more than one processor 910 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method comprising:
generating, by a computing system, an interactive game space for predicting an outcome of an event during a live game;
identifying, by the computing system, a prediction event in the live game;
receiving, by the computing system, event data for the live game up to the prediction event;
identifying, by the computing system, pre-game player specific data for each player involved in the prediction event;
generating, by the computing system, a probability distribution for a set of possible outcomes for the prediction event based on the event data and the pre-game player specific data;
presenting, by the computing system, the probability distribution to a user participating in the interactive game space;
receiving, by the computing system, a proposed outcome for the prediction event from the user participating in the interactive game space;
determining, by the computing system, that the proposed outcome was correct; and
based on the determining, granting, by the computing system, points to the user within the interactive game space.

2. The method of claim 1, wherein the probability distribution comprises a likelihood for each outcome of the set of possible outcomes occurring.

3. The method of claim 1, wherein identifying, by the computing system, the pre-game player specific data for each player involved in the prediction event comprises:
identifying historical event data for each player involved in the live game; and
generating the pre-game player specific data based on the historical event data for each player involved in the live game.

4. The method of claim 1, further comprising:
identifying, by the computing system, a second prediction event in the live game;
receiving, by the computing system, updated event data for the live game up to the second prediction event;
generating, by the computing system, a second probability distribution for a second set of possible outcomes for the second prediction event based on the updated event data and the pre-game player specific data;
presenting, by the computing system, the second probability distribution to the user participating in the interactive game space;
receiving, by the computing system, a second proposed outcome for the second prediction event from the user participating in the interactive game space; and
determining, by the computing system, that the proposed outcome was incorrect.

5. The method of claim 1, further comprising:
receiving, by the computing system, a second proposed outcome for the prediction event from a second user participating in the interactive game space, wherein the second user is not presented with the probability distribution.

6. The method of claim 5, wherein the user has a first type of membership account and the second user has a second type of membership account.

7. The method of claim 1, wherein the live game is a cricket match and the prediction event is a ball to be bowled from a bowler to a hitter.

8. A non-transitory computer readable medium comprising one or more sequences of instructions, which, when executed by a processor, causes a computing system to perform operations comprising:
generating, by the computing system, an interactive game space for predicting an outcome of an event during a live game;
identifying, by the computing system, a prediction event in the live game;
receiving, by the computing system, event data for the live game up to the prediction event;
identifying, by the computing system, pre-game player specific data for each player involved in the prediction event;
generating, by the computing system, a probability distribution for a set of possible outcomes for the prediction event based on the event data and the pre-game player specific data;
presenting, by the computing system, the probability distribution to a user participating in the interactive game space;
receiving, by the computing system, a proposed outcome for the prediction event from the user participating in the interactive game space;
determining, by the computing system, that the proposed outcome was correct; and
based on the determining, granting, by the computing system, points to the user within the interactive game space.

9. The non-transitory computer readable medium of claim 8, wherein the probability distribution comprises a likelihood for each outcome of the set of possible outcomes occurring.

10. The non-transitory computer readable medium of claim 8, wherein identifying, by the computing system, the pre-game player specific data for each player involved in the prediction event comprises:
identifying historical event data for each player involved in the live game; and
generating the pre-game player specific data based on the historical event data for each player involved in the live game.

11. The non-transitory computer readable medium of claim 8, further comprising:
identifying, by the computing system, a second prediction event in the live game;
receiving, by the computing system, updated event data for the live game up to the second prediction event;
generating, by the computing system, a second probability distribution for a second set of possible outcomes for the second prediction event based on the updated event data and the pre-game player specific data;
presenting, by the computing system, the second probability distribution to the user participating in the interactive game space;
receiving, by the computing system, a second proposed outcome for the second prediction event from the user participating in the interactive game space; and
determining, by the computing system, that the proposed outcome was incorrect.

12. The non-transitory computer readable medium of claim 8, further comprising:
receiving, by the computing system, a second proposed outcome for the prediction event from a second user participating in the interactive game space, wherein the second user is not presented with the probability distribution.

13. The non-transitory computer readable medium of claim 12, wherein the user has a first type of membership account and the second user has a second type of membership account.

14. The non-transitory computer readable medium of claim 8, wherein the live game is a cricket match and the prediction event is a ball to be bowled from a bowler to a hitter.

15. A system comprising:
a processor; and
a memory having programming instructions stored thereon, which, when executed by the processor, causes the system to perform operations comprising:
generating an interactive game space for predicting an outcome of an event during a live game;
identifying a prediction event in the live game;
receiving event data for the live game up to the prediction event;
identifying pre-game player specific data for each player involved in the prediction event;
generating a probability distribution for a set of possible outcomes for the prediction event based on the event data and the pre-game player specific data;
presenting the probability distribution to a user participating in the interactive game space;
receiving a proposed outcome for the prediction event from the user participating in the interactive game space;
determining that the proposed outcome was correct; and
based on the determining, granting points to the user within the interactive game space.

16. The system of claim 15, wherein the probability distribution comprises a likelihood for each outcome of the set of possible outcomes occurring.

17. The system of claim 15, wherein identifying the pre-game player specific data for each player involved in the prediction event comprises:
identifying historical event data for each player involved in the live game; and
generating the pre-game player specific data based on the historical event data for each player involved in the live game.

18. The system of claim 15, wherein the operations further comprise:
identifying a second prediction event in the live game;
receiving updated event data for the live game up to the second prediction event;
generating a second probability distribution for a second set of possible outcomes for the second prediction event based on the updated event data and the pre-game player specific data;
presenting the second probability distribution to the user participating in the interactive game space;
receiving a second proposed outcome for the second prediction event from the user participating in the interactive game space; and
determining that the proposed outcome was incorrect.

19. The system of claim 15, wherein the operations further comprise:
receiving a second proposed outcome for the prediction event from a second user participating in the interactive game space, wherein the second user is not presented with the probability distribution.

20. The system of claim 19, wherein the user has a first type of membership account and the second user has a second type of membership account.
